(19) United States
(12) Patent Application Publication
(10) Pub. No.: US 2013/0294220 A1
(43) Pub. Date: Nov. 7, 2013

(54) METHOD AND APPARATUS FOR TRANSMITTING AND RECEIVING SIGNALS

(71) Applicant: Electronics and Telecommunications Research Institute, (US)

(72) Inventors: Jong Soo LIM, Daejeon (KR); Sun Hyoung KWON, Seoul (KR); Heung Mook KIM, Daejeon (KR); Namho HUR, Daejeon (KR)

(73) Assignee: Electronics and Telecommunications Research Institute, Daejeon (KR)

(21) Appl. No.: 13/886,943

(22) Filed: May 3, 2013

(30) Foreign Application Priority Data
May 3, 2012 (KR) 10-2012-0047094
Apr. 19, 2013 (KR) 10-2013-0043769

(51) Int. Cl. H04L 5/12

(52) U.S. Cl. CPC H04L 5/12
USPC 370/215

(57) ABSTRACT

A transmission apparatus couples a first phase modulation signal for first input data and a second phase modulation signal for second input data according to a first coupling method and transmits the coupled signal, and a reception apparatus receives the coupled signal. The reception apparatus derives a signal in which a first phase modulation signal and a second phase modulation signal are coupled according to a second coupling method from a received signal and separates the first phase modulation signal and the second phase modulation signal from the received signal based on the received signal and the derived signal. Furthermore, the reception apparatus obtains the first input data by demodulating the first phase modulation signal and obtains the second input data by demodulating the second phase modulation signal.

### CROSS-REFERENCE TO RELATED APPLICATION

This application claims priority to and the benefit of Korean Patent Application Nos. 10-2012-0047094 and 10-2013-0043769 filed in the Korean Intellectual Property Office on May 3, 2012 and Apr. 19, 2013, the entire contents of which are incorporated herein by reference.

### BACKGROUND OF THE INVENTION

(a) Field of the Invention

The present invention relates to a method and apparatus for transmitting and receiving signals.

(b) Description of the Related Art

Amplitude modulation is a modulation scheme for changing the amplitude of a carrier depending on the intensity of an information signal and is characterized in that it is vulnerable to fading due to the multipath of radio waves and it has a high Peak-to-Average Power Ratio (PAPR) versus average power.

Meanwhile, phase modulation is characterized in that the amplitude of a carrier is constant because an information signal is carried on the phase of the carrier and the phase modulation has a relatively better noise characteristic than the amplitude modulation. Furthermore, the phase modulation has a very low PAPR, but requires a wider transmission bandwidth than the amplitude modulation.

In general, a high PAPR generates a non-linear distortion in the Power Amplifier (PA) of a transmitter. If sufficient back-off for power is not given, the frequency spectrum of a system is widened and distortion due to modulation between frequencies is generated, thereby deteriorating system performance.

As described above, the phase modulation can provide service using the low output of a transmitter owing to a better noise characteristic and a lower PAPR than the amplitude modulation, but has lower spectrum efficiency than the amplitude modulation.

Accordingly, a transmission/reception method and apparatus in accordance with exemplary embodiments of the present invention can be effectively used to develop transmission/reception modulation/demodulation apparatuses in the wireless communication field that requires high spectrum efficiency and the low output of a transmitter.

### SUMMARY OF THE INVENTION

The present invention has been made in an effort to provide a method and apparatus for transmitting and receiving signals having an advantage of improved spectrum efficiency when transmitting/receiving signals using phase modulation.

According to an embodiment of the present invention, a transmission method includes obtaining a first signal for first input data to be transmitted, obtaining a second signal for second input data to be transmitted, modulating the first signal into a first phase modulation signal having a value located within a first predetermined range, modulating the second signal into a second phase modulation signal having a value located within a second predetermined range, and coupling the first phase modulation signal and the second phase modulation signal and transmitting the coupled signal.

Each of the modulating of the first phase modulation signal and the modulating of the second phase modulation signal may include the steps of performing modulation on the corresponding signal based on symbol mapping, adjusting a phase value of the modulated signal in such a way as to be located within the corresponding predetermined range, and generating the corresponding phase modulation signal by performing phase modulation on the adjusted signal.

The coupling may include coupling the first phase modulation signal and the second phase modulation signal in a form A+B, A−B, −A+B, or −A−B assuming that the first phase modulation signal is A and the second phase modulation signal is B and transmitting the coupled signal.

According to another embodiment of the present invention, a transmission apparatus includes a first transmission processor for generating a first signal for first input data to be transmitted, a second transmission processor for generating a second signal for second input data to be transmitted, a first phase modulator for modulating the first signal into a first phase modulation signal, a second phase modulator for modulating the second signal into a second phase modulation signal, and a signal coupler for coupling the first phase modulation signal and the second phase modulation signal and transmitting the coupled signal. Here, the first phase modulation signal has a value located within a first predetermined range, and the second phase modulation signal has a value located within a second predetermined range.

The first transmission processor may perform modulation on the first signal based on symbol mapping, adjust a phase value of the modulated signal in such a way as to be located within the first predetermined range, and output the adjusted signal to the first phase modulator. Furthermore, the second transmission processor may perform modulation on the second signal based on symbol mapping, adjust a phase value of the modulated signal in such a way as to be located within the second predetermined range, and output the adjusted signal to the second phase modulator.

According to yet another embodiment of the present invention, a reception method includes receiving a reception signal in which a first phase modulation signal for first input data and a second phase modulation signal for second input data are coupled according to a first coupling method from a transmission apparatus, deriving a signal in which the first phase modulation signal and the second phase modulation signal are coupled according to a second coupling method from the reception signal, separating the first phase modulation signal and the second phase modulation signal from the reception signal based on the reception signal and the derived signal, obtaining the first input data by demodulating the first phase modulation signal, and obtaining the second input data by demodulating the second phase modulation signal.

Here, the deriving of a signal may include deriving the signal according to the second coupling method from the reception signal based on information indicating that the first phase modulation signal has been processed to have a value located within a first predetermined range and the second phase modulation signal has been processed to have a value located within a second predetermined range through the transmission apparatus.

Assuming that the first phase modulation signal is A and the second phase modulation signal is B, the deriving of a signal may include steps of deriving a signal according to the second coupling method having a form A−B or −A+B if the first coupling method has the form A+B, deriving a signal according to the second coupling method having a form A+B or −A+B if the first coupling method has the form A−B, deriving a signal according to the second coupling method having a form −A−B or A+B if the first coupling method has the form −A+B, and deriving a signal according to the second coupling method having a form −A+B or A−B if the first coupling method has the form −A−B.

According to yet another embodiment of the present invention, a reception apparatus includes a reception antenna for receiving a reception signal in which a first phase modulation signal for first input data and a second phase modulation signal for second input data are coupled according to a first coupling method from a transmission apparatus, a signal separator for deriving a signal in which the first phase modulation signal and the second phase modulation signal are coupled according to a second coupling method from the reception signal and separating the first phase modulation signal and the second phase modulation signal from the reception signal based on the reception signal and the derived signal, a first phase demodulator for obtaining the first input data by demodulating the first phase modulation signal, and a second phase demodulator for obtaining the second input data by demodulating the second phase modulation signal.

Here, the first phase modulation signal may have a value located within a first predetermined range, and the second phase modulation signal may have a value located within a second predetermined range.

In the method and apparatus according to an aspect of the present invention, the first predetermined range may be greater than

$$\frac{- π}{4}$$

and smaller than

$$\frac{π}{4} ,$$

and the second predetermined range may be greater than

$$\frac{π}{4}$$

smaller than

$$\frac{3 π}{4} .$$

### BRIEF DESCRIPTION OF THE DRAWINGS

FIG. 1 is a diagram showing the construction of a transmission apparatus in accordance with an exemplary embodiment of the present invention.

FIG. 2 is a diagram showing the construction of a reception apparatus in accordance with an exemplary embodiment of the present invention.

FIG. 3 is a flowchart illustrating a method of transmitting a signal in accordance with an exemplary embodiment of the present invention.

FIG. 4 is a flowchart illustrating a method of receiving a signal in accordance with an exemplary embodiment of the present invention.

FIG. 5 is an exemplary diagram illustrating that A-B can be derived from A+B in accordance with an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the entire specification, unless explicitly described to the contrary, the word “comprise” and variations, such as “comprises” or “comprising”, will be understood to imply the inclusion of stated elements but not the exclusion of any other elements.

Hereinafter, a method and apparatus for transmitting and receiving signals in accordance with exemplary embodiments of the present invention are described with reference to the accompanying drawings.

In accordance with an exemplary embodiment of the present invention, signals are transmitted and received using phase modulation. In order to improve the spectrum efficiency of phase modulation, two different phase-modulated signals are coupled before transmitting the two different phase-modulated signals and then transmitted through a given frequency bandwidth. A reception end performs phase demodulation on a received signal and then separates the phase-modulated signal into two different information signals. Here, the two different information signals are separated from the received signal using one reception antenna.

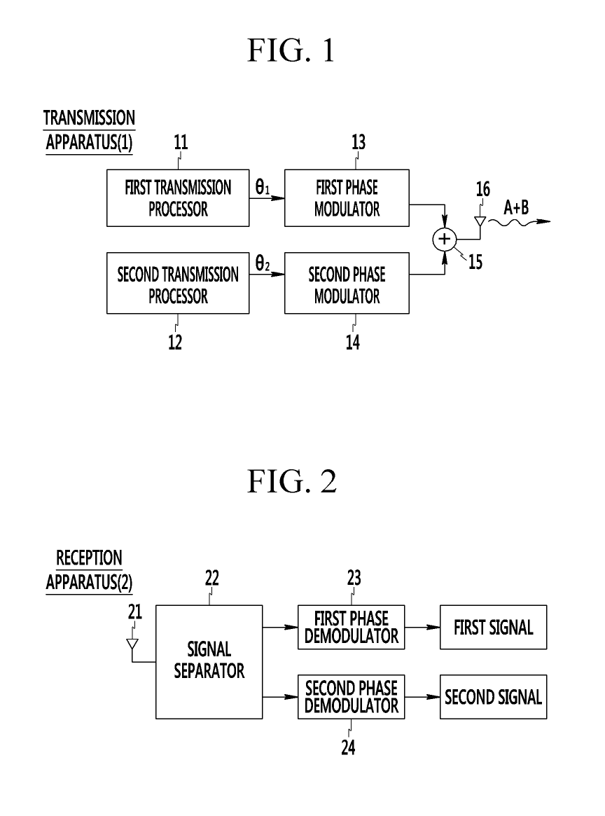

FIG. 1 is a diagram showing the construction of a transmission apparatus in accordance with an exemplary embodiment of the present invention.

As shown in FIG. 1, the transmission apparatus 1 includes a first transmission processor 11, a second transmission processor 12, a first phase modulator 13, a second phase modulator 14, a signal coupler 15, and a transmission antenna 16.

The first transmission processor 11 generates a first signal for input data, and the second transmission processor 11 generates a second signal for input data. Each of the first and the second transmission processors 11 and 12 converts the input data into parallel data and generates a symbol signal by mapping symbols to the parallel data. The symbol signal to which the symbols have been mapped is not a complex signal, but a signal having only a real number. Each of the first and the second signals can be a real signal. Here, the first and the second transmission processors 11 and 12 can perform modulation on signals based on symbol mapping and generate the first signal and the second signal by adjusting phase values of the modulated signals so that the phase value is located within a predetermined range. Here, the predetermined range in which the phase value is adjusted by the first transmission processor 11 may be different from the predetermined range in which the phase value is adjusted by the second transmission processor 12.

The first signal and the second signal generated by the first transmission processor 11 and the second transmission processor 12 can be subject to Inverse Fast Fourier Transform (IFFT), converted into signals of serial forms, and inputted to the first phase modulator 13 and the second phase modulator 14.

The first phase modulator 13 performs phase modulation on the first signal received from the first transmission processor 11, and the second phase modulator 14 performs phase modulation on the second signal received from the second transmission processor 12. The phase modulation is a scheme for carrying and transmitting an information signal on the phase of a carrier and known in the art, and thus a detailed description thereof is omitted. Signals outputted from the first and the second phase modulators 13 and 14 are hereinafter referred to as a first phase modulation signal and a second phase modulation signal, respectively, for convenience of description.

The signal coupler 15 couples the first phase modulation signal and the second phase modulation signal received from the first and the second phase modulators 13 and 14 and transmits the coupled signal through the transmission antenna 16.

FIG. 2 is a diagram showing the construction of a reception apparatus in accordance with an exemplary embodiment of the present invention. As shown in FIG. 2, the reception apparatus 2 includes a reception antenna 21, a signal separator 22, a first phase demodulator 23, and a second phase demodulator 24.

The reception antenna 21 receives a signal from the transmission apparatus 1, and the signal separator 22 separates a first reception signal and a second reception signal from the received signal. The first reception signal corresponds to a first phase modulation signal, and the second reception signal corresponds to a second phase modulation signal.

The first phase demodulator 23 obtains a first signal, that is, an information signal received from the transmission apparatus 1, by performing phase demodulation on the first reception signal received from the signal separator 22. The second phase demodulator 24 obtains a second signal, that is, an information signal received from the transmission apparatus 1, by performing phase demodulation on the second reception signal received from the signal separator 22.

Each of the first phase demodulator 23 and the second phase demodulator 24 can scale the received signal, process the scaled signal in a parallel form, perform Fast Fourier Transform (FFT) on the processed signal having a parallel form, and output a signal of a frequency domain. Each of the first phase demodulator 23 and the second phase demodulator 24 performs phase demodulation on the FFT signal and outputs the demodulated signal. The demodulated signal can be converted into a signal of a serial form and outputted as a signal, that is, the original information signal.

A method of transmitting a signal and a method of receiving a signal in accordance with an exemplary embodiment of the present invention are described below in connection with the transmission apparatus and the reception apparatus.

First, the method of transmitting a signal is described below.

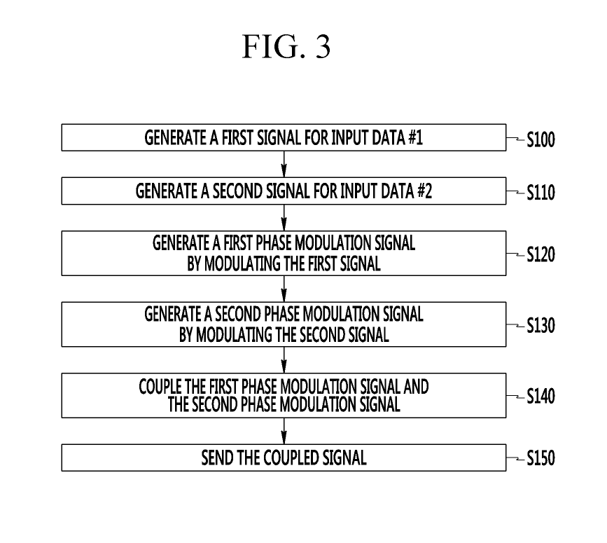

FIG. 3 is a flowchart illustrating the method of transmitting a signal in accordance with an exemplary embodiment of the present invention.

As shown in FIG. 3, when input data #1 is received, the first transmission processor 11 generates a first signal by processing the input data #1 and outputs the first signal at step S100. Furthermore, the second transmission processor 12 generates a second signal by processing input data #2 and outputs the second signal at step S110. More particularly, each of the input data #1 and the input data #2 is converted into a signal of a parallel form, subject to symbol mapping, and outputted as a symbol signal. The symbol signal is subject to IFFT and outputted as a signal of a time domain. The signal processed and outputted as described above is a signal having only a real number not a complex signal. If a minus (−) sign is added to a conjugate signal and IFFT is performed on the conjugate signal, the conjugate signal becomes a signal having only an imaginary part. Here, each of the first transmission processor 11 and the second transmission processor 12 can adjust a value of the signal so that the value is placed within a predetermined range. For example, a value of the first signal may be adjusted in such a way as to be located within a range that is greater than

$$\frac{- π}{4} ,$$

but smaller than

$$\frac{π}{4} ,$$

and a value of the second signal may be adjusted in such a way as to be located within a range that is greater than

$$\frac{π}{4} ,$$

but smaller than

$$\frac{3 π}{4} .$$

Next, the first phase modulator 13 performs phase modulation on the first signal and outputs a first phase modulation signal at step S120, and the second phase modulator 14 performs phase modulation on the second signal and outputs a second phase modulation signal at step S130.

The signal coupler 15 couples the first phase modulation signal and the second phase modulation signal at step S140 and transmits the coupled signal through the transmission antenna 16 at step S150.

The method of receiving a signal is described below.

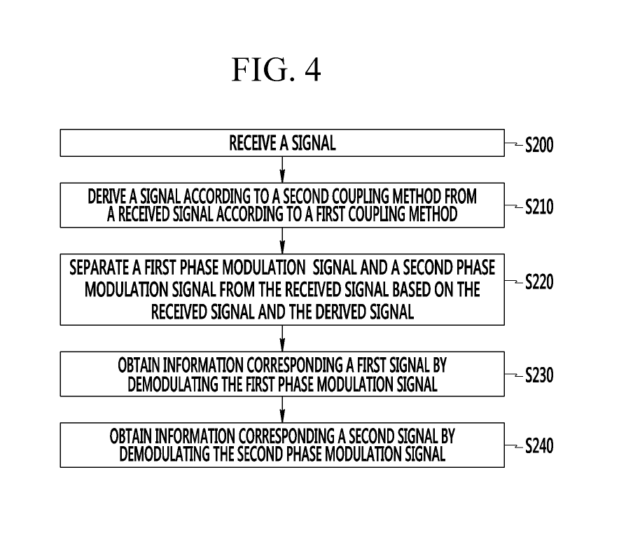

FIG. 4 is a flowchart illustrating the method of receiving a signal in accordance with an exemplary embodiment of the present invention.

A signal transmitted by the transmission apparatus 1 as described above is received by the reception apparatus 2 at step S200. As shown in FIG. 4, the reception apparatus 2 separates signals corresponding to a first phase modulation signal and a second phase modulation signal, respectively, from the received signal. The received signal is a signal obtained by performing phase modulation on input data #1 and input data #2 through the transmission apparatus 1. The signal separator 21 of the reception apparatus 2 separates a first reception signal, corresponding to the first phase modulation signal of the input data #1, and a second reception signal, corresponding to the second phase modulation signal of the input data #2, from the received signal.

In accordance with an exemplary embodiment of the present invention, the first phase modulation signal corresponding to the first reception signal and the second phase modulation signal corresponding to the second reception signal are obtained by deriving a signal, obtained by subtracting the second reception signal from the first reception signal, from a signal received from the transmission apparatus 1, that is, a signal in which the first reception signal and the second reception signal are coupled.

Assuming that a signal obtained by performing phase modulation on the input data #1 in the transmission apparatus 1, that is, the first phase modulation signal is “A”, a signal obtained by performing phase modulation on the input data #2 in the transmission apparatus 1, that is, the second phase modulation signal is “B”, and a signal transmitted by the transmission apparatus 1 is “X”, X=A+B.

Assuming that a first signal (i.e., a phase value) for the input data #1 outputted from the transmission apparatus 1 is θ₁ and a second signal (i.e., a phase value) for the input data #2 outputted from the transmission apparatus 1 is θ₂, the first phase modulation signal A and the second phase modulation signal B can be represented as follows.

A=e^{jθ}_{₁}, B=e^{jθ}_{₂}

The first and the second phase modulation signals are coupled and transmitted as the one signal X. Here, X may have a form of A+B, A−B, −A+B, or −A−B. First, assuming that X=A+B, a reception method is described below. More particularly, a signal according to a second coupling method is derived from a received signal according to a first coupling method. That is, A−B is derived from A+B, and values of A and B are calculated at step S210.

An angle of A−B can be derived to make a right angle with that of A+B using the following equation.

$$\begin{matrix}( \vec{A} + \vec{B} ) ( \vec{A} - \vec{B} ) = {\vert \vec{A} \vert}^{2} - \vec{A} \vec{B} + \vec{B} \vec{A} - {\vert \vec{B} \vert}^{2} \\ = {\vert \vec{A} \vert}^{2} - {\vert \vec{B} \vert}^{2} ∵ \vec{A} \vec{B} = \vec{B} \vec{A} = \vert \vec{A} \vert \vert \vec{B} \vert cos θ \\ = 0 ∵ \vert \vec{A} \vert = \vert \vec{B} \vert = 1\end{matrix} \\ ∴ ( \vec{A} + \vec{B} ) ⊥ ( \vec{A} - \vec{B} ) \qquad [ Equation 2 ]$$

Since (\vec{A}+\vec{B}) is orthogonal to (\vec{A}−\vec{B}) as in Equation 2, ∠(\vec{A}−\vec{B}) can have two values as in ∠(\vec{A}+\vec{B})±π/2. Here, if the transmission apparatus 1 properly determines the ranges of values of A and B, the ∠(\vec{A}−\vec{B}) value can be uniquely derived.

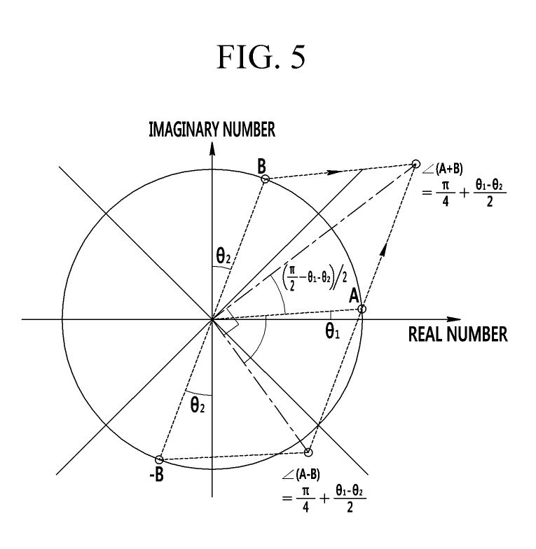

FIG. 5 is an exemplary diagram illustrating that A−B can be derived from A+B in accordance with an exemplary embodiment of the present invention.

From FIG. 5, it can be seen that when values of A and B are set within a proper range, A−B can be derived from A+B. For example, assuming that

$$- \frac{π}{4} \leq A \leq \frac{π}{4} and \frac{π}{4} \leq B \leq \frac{3 π}{4} ,$$

A+B is always located in a first quadrant and A−B is always located in a fourth quadrant, as shown in FIG. 5. Therefore, if the transmission apparatus 1 previously sets values of A and B within a predetermined range, a precise angle of A−B can be derived. As described above, the transmission apparatus 1 adjusts values of the first signal and the second signal in such a way to be located within a predetermined range. Accordingly, the first phase modulation signal A obtained by performing phase modulation on the first signal and the second phase modulation signal B obtained by performing phase modulation on the second signal are located within a range of

$$- \frac{π}{4} \leq A \leq \frac{π}{4}$$

and a range of

$$\frac{π}{4} \leq B \leq \frac{3 π}{4} .$$

As described above, the reception apparatus 2 knows that the transmission apparatus 1 couples the first phase modulation signal A and the second phase modulation signal B having values located within predetermined ranges and transmits the coupled signal. The amount of A−B can be calculated using the following equation.

$$\begin{matrix}4 = {( 2 \vec{A} )}^{2} \\ = {[ ( \vec{A} + \vec{B} ) + ( \vec{A} - \vec{B} ) ]}^{2} \\ = {( \vec{A} + \vec{B} )}^{2} + 2 ( \vec{A} + \vec{B} ) ( \vec{A} - \vec{B} ) + {( \vec{A} - \vec{B} )}^{2} \\ = {( \vec{A} + \vec{B} )}^{2} + {( \vec{A} - \vec{B} )}^{2}\end{matrix} \\ ∴ \vert \vec{A} - \vec{B} \vert = \sqrt{4 - {( \vec{A} + \vec{B} )}^{2}} \qquad [ Equation 3 ]$$

A−B can be calculated based on Equation 2 and Equation 3.

Furthermore, A and B are separated from A+B based on A−B as follows at step S220.

\vec{A}=[(\vec{A}+\vec{B})+(\vec{A}−\vec{B})]/2

\vec{B}=[(\vec{A}+\vec{B})+(\vec{A}−\vec{B})]/2 [Equation 4]

As described above, A and B separated from the received signal X by the signal separator 22 are inputted to the first phase demodulator 23 and the second phase demodulator 24, respectively. The first phase demodulator 23 obtains an information signal transmitted by the transmission apparatus 1 by performing phase demodulation on the first reception signal received from the signal separator 22, that is, A, at step S230. The second phase demodulator 24 obtains an information signal transmitted by the transmission apparatus 1 by performing phase demodulation on the second reception signal received from the signal separator 22, that is, B, at step S240.

θ₁ and θ₂, that is, the obtained information signals, are as follows.

$${θ}_{1} = \frac{log A}{j} \\ {θ}_{2} = \frac{log B}{j} \qquad [ Equation 5 ]$$

θ₁ and θ₂, that is, the restored information signals, indicate the first signal and the second signal, that is, the original signals.

Results derived using the coupling methods based on the evidence that A−B is derived in relation to the aforementioned coupling method for X=A+B are as follows.

TABLE 1

| Coupling | | |
|---|---|---|
| method | Derivable signal 1 | Derivable signal 2 |
| A + B | A − B | −A + B |
| | $∠ ( \vec{A} - \vec{B} ) = ∠ ( \vec{A} + \vec{B} ) \pm \frac{π}{2}$ | $∠ ( - \vec{A} + \vec{B} ) = ∠ ( \vec{A} + \vec{B} ) \pm \frac{π}{2}$ |
| | $\vert \vec{A} - \vec{B} \vert = \sqrt{4 - {( \vec{A} + \vec{B} )}^{2}}$ | $\vert - \vec{A} + \vec{B} \vert = \sqrt{4 - {( \vec{A} + \vec{B} )}^{2}}$ |
| A − B | A + B | −A − B |
| | $∠ ( \vec{A} + \vec{B} ) = ∠ ( \vec{A} - \vec{B} ) \pm \frac{π}{2}$ | $∠ ( - \vec{A} - \vec{B} ) = ∠ ( \vec{A} - \vec{B} ) \pm \frac{π}{2}$ |
| | $\vert \vec{A} + \vec{B} \vert = \sqrt{4 - {( \vec{A} - \vec{B} )}^{2}}$ | $\vert \vec{- A} - \vec{B} \vert = \sqrt{4 - {( \vec{A} - \vec{B} )}^{2}}$ |
| −A + B | −A − B | A + B |
| | $∠ ( - \vec{A} - \vec{B} ) = ∠ ( - \vec{A} + \vec{B} ) \pm \frac{π}{2}$ | $∠ ( \vec{A} + \vec{B} ) = ∠ ( - \vec{A} + \vec{B} ) \pm \frac{π}{2}$ |
| | $\vert - \vec{A} - \vec{B} \vert = \sqrt{4 - {( - \vec{A} - \vec{B} )}^{2}}$ | $\vert \vec{A} + \vec{B} \vert = \sqrt{4 - {( - \vec{A} + \vec{B} )}^{2}}$ |
| −A − B | −A + B | A − B |
| | $∠ ( - \vec{A} + \vec{B} ) = ∠ ( - \vec{A} - \vec{B} ) \pm \frac{π}{2}$ | $∠ ( \vec{A} - \vec{B} ) = ∠ ( - \vec{A} - \vec{B} ) \pm \frac{π}{2}$ |
| | $\vert - \vec{A} + \vec{B} \vert = \sqrt{4 - {( - \vec{A} - \vec{B} )}^{2}}$ | $\vert \vec{A} - \vec{B} \vert = \sqrt{4 - {( - \vec{A} - \vec{B} )}^{2}}$ |

As in Table 1, it can be seen that derivable signals are present depending on a method of the transmission apparatus 1 coupling the first phase modulation signal and the second phase modulation signal. For example, a signal A−B or −A+B according to a second coupling method can be derived from a signal A+B according to a first coupling method, a signal A+B or −A−B according to the second coupling method can be derived from a signal A−B according to the first coupling method, a signal −A−B or A+B according to the second coupling method can be derived from a signal −A+B according to the first coupling method, and a signal −A+B or A−B according to the second coupling method can be derived from a signal −A−B according to the first coupling method. As described above, when two independent phase modulation signals are coupled using various coupling method A+B, A−B, −A+B, and −A−B, such as those of Table 1, one coupled signal is transmitted through the transmission apparatus, the reception apparatus can receive the transmitted signal and separate the two original signals from the received signal.

In accordance with an exemplary embodiment of the present invention, the transmission end transmits a given frequency bandwidth by coupling two different phase-modulated signals, and the reception side obtains two different information signals by performing phase demodulation on a received signal. Accordingly, spectrum efficiency can be increased twice existing phase modulation because two independent phase signals can be transmitted in a given spectrum.

The exemplary embodiments of the present invention are not implemented by way of only the method and/or the apparatus, but may be implemented by way of a program for realizing a function corresponding to a construction according to an exemplary embodiment of the present invention or a recording medium on which the program is recorded. The implementations will be evident to a person having ordinary skill in the art to which the present invention pertains from the embodiments.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A transmission method, comprising steps of:
obtaining a first signal for first input data to be transmitted;
obtaining a second signal for second input data to be transmitted;
modulating the first signal into a first phase modulation signal having a value located within a first predetermined range;
modulating the second signal into a second phase modulation signal having a value located within a second predetermined range; and
coupling the first phase modulation signal and the second phase modulation signal and transmitting the coupled signal.

2. The transmission method of claim 1, wherein each of the modulating of the first phase modulation signal and the modulating of the second phase modulation signal comprises:
performing modulation on the corresponding signal based on symbol mapping;
adjusting a phase value of the modulated signal in such a way as to be located within the corresponding predetermined range; and
generating the corresponding phase modulation signal by performing phase modulation on the adjusted signal.

3. The transmission method of claim 1, wherein:
the first predetermined range is greater than
$$- \frac{π}{4}$$
and smaller than
$$\frac{π}{4} ,$$
and
the second predetermined ranged is greater than
$$\frac{π}{4}$$
smaller than
$$\frac{3 π}{4} .$$

4. The transmission method of claim 1, wherein the coupling comprises coupling the first phase modulation signal and the second phase modulation signal in a form A+B, A−B, −A+B, or −A−B assuming that the first phase modulation signal is A and the second phase modulation signal is B and transmitting the coupled signal.

5. A transmission apparatus, comprising:
a first transmission processor for generating a first signal for first input data to be transmitted;
a second transmission processor for generating a second signal for second input data to be transmitted;
a first phase modulator for modulating the first signal into a first phase modulation signal;
a second phase modulator for modulating the second signal into a second phase modulation signal; and
a signal coupler for coupling the first phase modulation signal and the second phase modulation signal and transmitting the coupled signal,
wherein the first phase modulation signal has a value located within a first predetermined range, and the second phase modulation signal has a value located within a second predetermined range.

6. The transmission apparatus of claim 5, wherein:
the first transmission processor performs modulation on the first signal based on symbol mapping, adjusts a phase value of the modulated signal in such a way as to be located within the first predetermined range, and outputs the adjusted signal to the first phase modulator, and
the second transmission processor performs modulation on the second signal based on symbol mapping, adjusts a phase value of the modulated signal in such a way as to be located within the second predetermined range, and outputs the adjusted signal to the second phase modulator.

7. The transmission apparatus of claim 5, wherein assuming that the first phase modulation signal is A and the second phase modulation signal is B, the first phase modulation signal and the second phase modulation signal are coupled in a form A+B, A−B, −A+B, or −A−B and transmitted.

8. A reception method, comprising steps of:
receiving a reception signal in which a first phase modulation signal for first input data and a second phase modulation signal for second input data are coupled according to a first coupling method from a transmission apparatus;
deriving a signal in which the first phase modulation signal and the second phase modulation signal are coupled according to a second coupling method from the reception signal;
separating the first phase modulation signal and the second phase modulation signal from the reception signal based on the reception signal and the derived signal;
obtaining the first input data by demodulating the first phase modulation signal; and
obtaining the second input data by demodulating the second phase modulation signal.

9. The reception method of claim 8, wherein the deriving of a signal comprises deriving the signal according to the second coupling method from the reception signal based on information indicating that the first phase modulation signal has been processed to have a value located within a first predetermined range and the second phase modulation signal has been processed to have a value located within a second predetermined range through the transmission apparatus.

10. The reception method of claim 9, wherein:
the first predetermined range is greater than
$$- \frac{π}{4}$$
and smaller than
$$\frac{π}{4} ,$$
and
the second predetermined range is greater than
$$\frac{π}{4}$$
smaller than
$$\frac{3 π}{4} .$$

11. The reception method of claim 8, wherein assuming that the first phase modulation signal is A and the second phase modulation signal is B, the first coupling method has a form A+B, A−B, −A+B, or −A−B.

12. The reception method of claim 11, wherein the deriving of a signal comprises:
deriving a signal according to the second coupling method having a form A−B or −A+B if the first coupling method has the form A+B;
deriving a signal according to the second coupling method having a form A+B or −A+B if the first coupling method has the form A−B;
deriving a signal according to the second coupling method having a form −A−B or A+B if the first coupling method has the form −A+B; and
deriving a signal according to the second coupling method having a form −A+B or A−B if the first coupling method has the form −A−B.

13. A reception apparatus, comprising:
a reception antenna for receiving a reception signal in which a first phase modulation signal for first input data and a second phase modulation signal for second input data are coupled according to a first coupling method from a transmission apparatus;
a signal separator for deriving a signal in which the first phase modulation signal and the second phase modulation signal are coupled according to a second coupling method from the reception signal and separating the first phase modulation signal and the second phase modulation signal from the reception signal based on the reception signal and the derived signal;
a first phase demodulator for obtaining the first input data by demodulating the first phase modulation signal; and
a second phase demodulator for obtaining the second input data by demodulating the second phase modulation signal.

14. The reception apparatus of claim 13, wherein the first phase modulation signal has a value located within a first predetermined range, and the second phase modulation signal has a value located within a second predetermined range.

15. The reception apparatus of claim 14, wherein:
assuming that the first phase modulation signal is A and the second phase modulation signal is B, the first coupling method has a form A+B, A−B, −A+B, or −A−B, and
the signal separator derives a signal according to the second coupling method having a form A−B or −A+B if the first coupling method has the form A+B, derives a signal according to the second coupling method having a form A+B or −A+B if the first coupling method has the form A−B, derives a signal according to the second coupling method having a form −A−B or A+B if the first coupling method has the form −A+B, and derives a signal according to the second coupling method having a form −A+B or A−B if the first coupling method has the form −A−B.
